(19) United States
(12) Patent Application Publication
(10) Pub. No.: US 2023/0250851 A1
(43) Pub. Date: Aug. 10, 2023

(54) SUBASSEMBLY WITH A WHEEL BEARING AND A CONSTANT VELOCITY JOINT

(71) Applicant: AKTIEBOLAGET SKF, Goteborg (SE)

(72) Inventors: Tom SCHMITZ, Hambach (DE); Klaus Dietmar RIPPSTEIN, Ebelsbach (DE); Lisa Angelika BAIERL, Schweinfurt (DE)

(21) Appl. No.: 18/101,202

(22) Filed: Jan. 25, 2023

(30) Foreign Application Priority Data
Feb. 4, 2022 (DE) 102022201180.5

(51) Int. Cl. F16D 1/068

(52) U.S. Cl. CPC F16D 1/068

(57) ABSTRACT

A method for connecting a constant velocity joint having a bell and a shaft to a wheel bearing having an opening, the shaft being oversized relative to the opening, includes applying an adhesive to the shaft and/or the opening, the adhesive in an uncured state being configured to reduce a coefficient of friction between the shaft and the opening, pressing the shaft into the opening to form a press connection between the shaft and the wheel bearing, and curing the adhesive or allowing the adhesive to cure. Also a subassembly formed by the method.

### CROSS-REFERENCE

This application claims priority to German patent application no. 10 2022 201 180.5 filed on Feb. 4, 2022, the contents of which are fully incorporated herein by reference.

### TECHNOLOGICAL FIELD

The present disclosure is directed to a subassembly including a wheel bearing and a constant velocity joint connected by an adhesive and to a method of connecting a constant velocity joint to a wheel bearing.

### BACKGROUND

Especially in the field of electric mobility, there is currently the desire to produce lighter-weight vehicles by saving weight, in order to, for example, reduce the consumption of an electric vehicle or to increase the range of the electric vehicle.

In order to achieve this desired weight reduction, in addition to providing lighter components, it can also be necessary to make the connections between two or more components lighter. This can be done, for example, by omitting connecting elements such as bolts, screws, nuts, etc. and generating the connections between the two or more components directly, for example, via a press connection.

In a press connection, two components, one being oversized relative to the other, are pressed together in order to achieve a connection between the two components. The larger the oversize between the two components, the greater the force can be that can be transmitted by the press connection. However, with a large oversize it is necessary to provide a lubricating layer between the first component and the second component, which lubricating layer makes the pressing together possible. However, this lubricating layer remains to a certain extent even after the pressing together of the two components and can disadvantageously affect the level of the transmissible force.

### SUMMARY

It is therefore an aspect of the present disclosure to provide an improved press connection between a constant velocity joint and a wheel bearing that allows for an improved force transmission.

In the following a subassembly of a wheel bearing and a constant velocity joint is presented in which the constant velocity joint includes a bell with a shaft, the shaft being connected to the wheel bearing by a press connection, and the shaft and the wheel bearing being configured to transmit a torque between themselves. The shaft is oversized compared to the wheel bearing. In particular, the shaft and/or the wheel bearing can be configured as a single component or as a group of different components that are, for example, connected to one another directly or indirectly. Furthermore, the subassembly can be configured for use in a vehicle, such as, for example, a motor vehicle, in particular an electric vehicle or hybrid vehicle.

In order to increase the torque transmissible between the shaft of the constant velocity joint and the wheel bearing, an adhesive layer, serving as a lubricating layer during assembly, is provided between the shaft and the wheel bearing. During assembly, the adhesive acts as a lubricating layer or lubricating film that facilitates the press connection between the shaft and the wheel bearing by reducing a coefficient of friction between the shaft and the wheel bearing. After the assembly, the coefficient of friction increases again between the two components, since the cohesion and adhesion of the adhesive develops, so that the torque transmissible by the press connection is increased, in particular in comparison to a conventional press connection.

The shaft preferably is oversized, in particular an oversize according to the definitions that are specified, for example, in DIN 7190, by at least 5‰, preferably between 8‰ and 15‰. This makes it possible to increase a normal force that acts in the press connection between the two components and thereby to increase the torque transmissible from the shaft to the wheel bearing.

According to a further exemplary embodiment, an adhesive forming the adhesive layer is a curing adhesive, in particular a self-curing adhesive. This makes it possible to increase the coefficient of friction between the shaft and the wheel bearing after joining the two components. The adhesive is advantageously suited to cure in the press joint. The adhesive is preferably a chemically and/or anaerobically curing adhesive, such as, for example, an epoxy adhesive or a retaining (joining) adhesive. Alternatively or additionally, heat can also be used in order to promote the curing of the adhesive.

For example, the shaft can have a first region and a second region, the second region being disposed on a side facing away from the constant velocity joint, in which the first region is configured to come into contact with the wheel bearing after the pressing, and the second region is provided with a thread. In particular, the thread can be configured to interact with a nut in order to secure the shaft to the wheel bearing over and above the press fit and/or in order to set a preload of the wheel bearing. Alternatively the second region can be omitted. This is possible, for example, when the wheel bearing already has a preset preload. By omitting the second region, the subassembly can be designed lighter.

Furthermore, the shaft can be hollow and thus lighter. Furthermore, the first region of the shaft can preferably have a cylindrical or conical shape. In particular, a conical shape has the advantage that a centering of the shaft in the wheel bearing is facilitated.

According to a further preferred embodiment, at least one surface of the shaft and/or of the wheel bearing, which surface comes into contact with the respective other one during the connecting, is surface treated and/or has an increased coefficient of friction. For example, the surface may be phosphated, etched, galvanized, and/or blasted, in particular sandblasted and/or shotblasted. This makes it possible to increase the coefficient of friction of the surface in the region that comes into contact with the other component, whereby the torque transmissible by the press connection is increased. Alternatively or additionally, the adhesive can also be configured to roughen the surface and/or to increase the coefficient of friction of the surface. For example, the adhesive can have etching properties and/or be a filled adhesive, i.e., be an adhesive that is filled with further substances, in particular substances increasing the coefficient of friction.

The torque that can be transmitted between the shaft and the wheel bearing is preferably at least 4000 Nm. In conventional press connections in which the lubricating layer is formed from a lubricant or the like, this lubricating layer can limit the maximum force transmissible by a press connection or the maximum transmissible torque. A conventional press connection therefore cannot be used in certain applications since the force transmissible by the press connection is lower than the force required for the intended application. In contrast thereto, however, in the described device the maximum transmissible force or the maximum transmissible torque is increased so that the described subassembly can advantageously also be used in a drive shaft of a vehicle. In particular, with the described device in the specified dimensions, the transmissible torque can be essentially doubled.

According to a further aspect of the invention, a method is provided for connecting a wheel bearing to a constant velocity joint. The method comprises:

providing a wheel bearing and a constant velocity joint that includes a bell with a shaft, the shaft being oversized compared to the wheel bearing, applying a lubricant onto the shaft and/or the wheel bearing, the lubricant being an adhesive, and press connecting the shaft and the wheel bearing.

The method preferably further includes treating the surface of the shaft and/or the wheel bearing in the region of the to-be-formed press connection in order to increase a coefficient of friction of the surface. This allows for a greater force transmission between the two components. Here treating the surface can comprise a phosphating, an etching, a galvanizing, and/or a blasting, in particular sandblasting and/or shotblasting.

According to a further preferred embodiment, the method further includes curing the adhesive. Here a curing adhesive, in particular a self-curing adhesive, can preferably be used. The adhesive is advantageously suited to cure in the press joint. The adhesive is preferably a chemically and/or anaerobically curing adhesive, such as, for example, an epoxy adhesive or a retaining (joining) adhesive. Alternatively or additionally, heat can also be used in order to promote the curing of the adhesive. This makes possible in a reliable manner the formation of the cohesion and adhesion of the adhesive. Alternatively or additionally, the adhesive can also be configured to roughen the surface and/or to increase the coefficient of friction of the surface. For example, the adhesive can be a filled adhesive, i.e., an adhesive that is filled with further substances, in particular substances increasing the coefficient of friction. The application of the adhesive can be effected, for example, two-dimensionally or linearly.

Further advantages and advantageous embodiments are specified in the description, the drawings, and the claims. Here in particular the combinations of features specified in the description and in the drawings are purely exemplary so that the features can also be present individually or combined in other ways.

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

### BRIEF DESCRIPTION OF THE DRAWINGS

FIG. 1 is a schematic view of a subassembly with a wheel bearing and a constant velocity joint according to a first embodiment of the present disclosure.

FIG. 2 is a schematic view of a subassembly with a wheel bearing and a constant velocity joint according to a second embodiment of the present disclosure.

FIG. 3 is a flow diagram for a method for connecting a wheel bearing to a constant velocity joint according to the present disclosure.

### DETAILED DESCRIPTION

In the following, identical or functionally equivalent elements are designated by the same reference numbers.

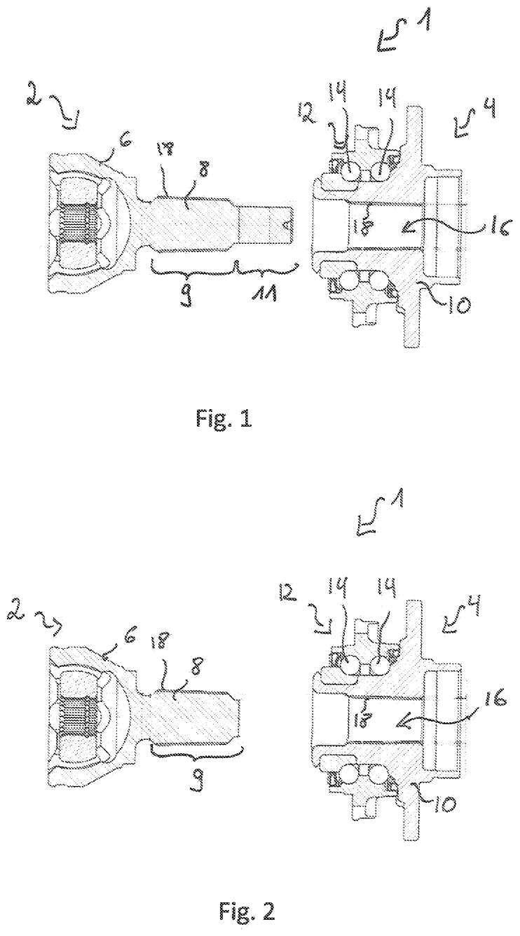

FIG. 1 shows a subassembly 1 according to a first embodiment that is configured to transmit a torque from a constant velocity joint 2 to a wheel bearing 4. The constant velocity joint comprises a bell 6 that includes a shaft 8, and the wheel bearing 4 comprises a hub 10 as well as a bearing unit 12 with a plurality of rolling elements 14. In FIG. 1 a shaft 8 made of solid material is shown. Alternatively the shaft 8 can also be configured as a hollow shaft.

In FIG. 1 the shaft 8 includes a first region 9 that is conical and a second region 11 that is provided with a thread. The hub 10 further comprises a bore 16. The cone angle of the first region 9 of the shaft 8 can fall, for example, between 0 and 89.5 degrees. Alternatively the first region 9 of the shaft 8 can also have a cylindrical shape.

In order to form the subassembly 1, the first region 9 of the shaft 8 and the hub 10 of the wheel bearing 4 are connected to each other by a press connection (press fit) so that the torque can be transmitted between the shaft 8 and the wheel bearing 4. So that the connection between the shaft 8 and the hub 10 can transmit the torque, a diameter of the first region 9 of the shaft 8 is oversized compared to the bore 16 of the hub 10. In FIG. 1 the first region 9 of the shaft 8 is oversized by at least 5‰, preferably between 8 and 15‰. After assembly, the second region 11 of the shaft 8 can protrude from the bore 16 so that a nut (not depicted) can be screwed onto the thread. The nut can secure the shaft 8 to the wheel bearing 4 over and above the press fit and/or set a preload of the wheel bearing 4.

In order to increase the torque transmissible from the shaft 8 to the wheel bearing 4, an adhesive layer 18, serving as a lubricating layer during assembly, is provided between the first region 9 of the shaft 8 and the wheel hub 10. In FIG. 1 the adhesive layer 18 is applied in particular in the region in which the shaft 8 and the hub 10 contact each other after the assembly. As can be seen in FIG. 1, the adhesive layer 8 is applied both to the shaft 8 and the inner side of the bore 16 of the hub 10. Alternatively also only one of the two components can be provided with the adhesive layer 8.

During assembly, the adhesive acts as a lubricating layer that facilitates the press connection between the shaft 8 and the hub 10 by reducing a coefficient of friction between the two components because the adhesive layer 18 serves as a lubricating layer. After the assembly, the adhesive cures so that the coefficient of friction between the shaft 8 and the hub 10 increases again, and the torque transmissible by the press connection is thereby increased, in particular in comparison to a conventional press connection. The adhesive functions as an adhesive in its uncured state and as an adhesive after it cures.

The adhesive used for the adhesive layer 18 is a curing adhesive so that after assembly the coefficient of friction between the two components is increased by the cured adhesive. For example, the adhesive can be an anaerobically curing adhesive and/or a chemically curing adhesive in which heat can advantageously be used in order to promote the curing of the adhesive.

In addition to the adhesive layer 18, a surface of the shaft 8 and/or the surface of the bore 16 that come into contact during the connecting can have an increased coefficient of friction. This can be achieved, for example, by a corresponding surface treatment. For example, the surface can be phosphated, etched, galvanized, and/or blasted, in particular sandblasted and/or shotblasted. Alternatively or additionally, the adhesive can also be configured to roughen the surface and/or to increase the coefficient of friction of the surface. For example, the adhesive can have etching properties and/or be a filled adhesive, i.e., be an adhesive that is filled with further substances, in particular substances increasing the coefficient of friction.

FIG. 2 shows a subassembly 1 according to a second embodiment. The subassembly of FIG. 2 differs from the subassembly 1 of FIG. 1 in that the shaft has only a first region 9, and the second region 11 is omitted. In comparison to the embodiment shown in FIG. 1, a weight reduction can thereby be achieved.

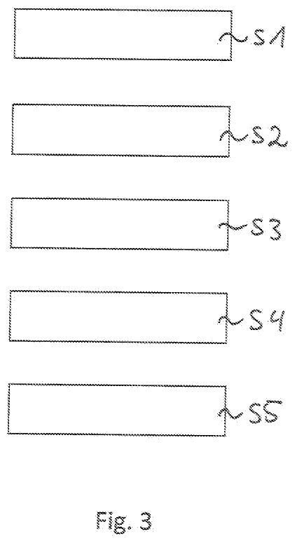

FIG. 3 shows a schematic flow diagram for a method for connecting a wheel bearing 4 to a constant velocity joint 2. In a first step S1, the method comprises providing a wheel bearing 4 and a constant velocity joint 2 that includes a bell 6 with a shaft 8, where the shaft 8 is oversized compared to the wheel bearing 4. In step S2 a lubricant is applied onto the shaft 8 and/or the bore 16 of the wheel bearing 4, the lubricant being a curing adhesive. The application of the adhesive can be effected, for example, two-dimensionally or linearly.

The two components are then pressed together in a step S3, and then the adhesive cures in a step S4. In order to increase the maximum torque that can be transmitted between the shaft 8 and the hub 10 of the wheel bearing 4, the method can furthermore include treating S5 the surfaces of the shaft 8 and/or of the bore 16 of the hub 10 in the region of the to-be-formed press connection in order to increase the coefficient of friction of the surface. Here the surface treatment can be effected, for example, prior to the application of the adhesive or even during the application of the adhesive, for example, by an adhesive being used that can be configured to roughen the surface and/or to increase the coefficient of friction of the surface.

In summary, by the use of an adhesive layer 18 as a lubricating layer that makes possible the pressing together of the shaft 8 of the constant velocity joint 2 and the hub 10 of the wheel bearing 4 in a manner that increases the torque transmissible between the shaft 8 and the hub 10. Here with specified dimensions the torque that can be transmitted between the shaft 8 and the hub 10 of the wheel bearing 4 is essentially doubled so that the described subassembly 1 or the described method can advantageously also be used for connections in vehicles.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved subassemblies of wheel bearings and constant velocity joints.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Subassembly
2 Constant velocity joint
4 Wheel bearing
6 Bell
8 Shaft
9 First region
10 Hub
11 Second region
12 Bearing unit
14 Rolling element
16 Bore
18 Adhesive layer
S1-S5 Method steps

What is claimed is:

1. A method for connecting a constant velocity joint having a bell and a shaft to a wheel bearing having an opening, the shaft being oversized relative to the opening, the method comprising:
applying an adhesive to the shaft and/or the opening, the adhesive in an uncured state being configured to reduce a coefficient of friction between the shaft and the opening,
pressing the shaft into the opening to form a press connection between the shaft and the wheel bearing, and
curing the adhesive or allowing the adhesive to cure.

2. The method according to claim 1, including:
before applying the adhesive, treating a surface of the shaft and/or the opening in the region of a to-be-formed press connection in order to increase a coefficient of friction of the surface.

3. The method according to claim 2, wherein the treating comprises phosphating, etching, galvanizing, sandblasting and/or shotblasting.

4. The method according to claim 1,
wherein the shaft is oversized relative to the opening by 8 to 15‰.

5. The method according to claim 1,
wherein the adhesive is an anaerobically curing adhesive and/or a chemically curing adhesive.

6. The method according to claim 1,
wherein the shaft includes a first region and a second region, the first region being located between the second region and the bell, the second region including a thread,
wherein the opening is a through opening,
wherein applying the adhesive comprises applying the adhesive to the first region, and
wherein the method further comprises inserting the second region through the through opening such that the second region projects from the through opening and the first region forms the press connection with the through opening.

7. The method according to claim 6,
wherein the press connection is configured to transmit at least 4000 Nm of torque between the wheel bearing and the shaft.

8. The method according to claim 1,
wherein the press connection is configured to transmit at least 4000 Nm of torque between the wheel bearing and the shaft.

9. A subassembly formed by the method according to claim 1.

10. A subassembly comprising:
a wheel bearing having an opening, and
a constant velocity joint having a bell and a shaft, the shaft extending into the opening,
wherein the shaft is oversized relative to the opening and connected to the wheel bearing by a press connection that is configured to transmit torque between the wheel bearing and the shaft,
wherein a layer of adhesive is provided between the shaft and the wheel bearing, and
wherein the adhesive in an uncured state is configured to reduce a coefficient of friction between the shaft and the opening.

11. The subassembly according to claim 10,
wherein the shaft is oversized by 8 to 15‰ relative to the opening.

12. The subassembly according to claim 10,
wherein the adhesive is an anaerobically curing adhesive and/or a chemically curing adhesive.

13. The subassembly according to claim 10,
wherein the shaft includes a first region and a second region, the first region being located between the second region and the bell, the second region including a thread,
wherein the opening is a through opening,
wherein the adhesive is applied to the first region, and
wherein the second region projects out of the through opening and the press connection is formed between the first region and the opening.

14. The subassembly according to claim 13,
wherein the press connection is configured to transmit at least 4000 Nm of torque between the wheel bearing and the shaft.

15. The subassembly according to claim 10,
wherein a first region of the shaft is cylindrical or conical.

16. The subassembly according to claim 10,
wherein a surface of the shaft located inside the opening is surface-treated to have an increased coefficient of friction.

17. The subassembly according to claim 16, wherein the surface is phosphated, etched, galvanized, sandblasted and/or shotblasted

18. The subassembly according to claim 10,
wherein the shaft is hollow.

19. The subassembly according to claim 10,
wherein the press connection is configured to transmit at least 4000 Nm of torque between the wheel bearing and the shaft.
